(19) United States
(12) Patent Application Publication
(10) Pub. No.: US 2008/0111281 A1
(43) Pub. Date: May 15, 2008

(54) Gas assisted injection molding method

(75) Inventors: Ken Love, Collinston, UT (US); Chuck Richards, Farmington, UT (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 11/599,148

(22) Filed: Nov. 14, 2006

(51) Int. Cl. B28B 7/12

(52) U.S. Cl. 264/335; 425/556

(57) ABSTRACT

A gas assisted method for molding a substrate is described, as a well as an apparatus for performing this molding process. Generally, this molding method will involve using a mold with a core side and a cavity side. The mold is designed to mold a substrate when filled with the thermoplastic. A quantity of thermoplastic is injected into the mold. Once the plastic is in the mold, gas is vented to the core side of the mold as the thermoplastic cools. The gas is introduced via sintered vents that have been added to the mold. In general, the gas will have a pressure less than 500 psi. Once the thermoplastic cools, the substrate is formed and can be ejected from the mold.

### BACKGROUND OF THE INVENTION

Injection molding processes are well known and used to mass-produce products made of thermoplastic. Common items that are made from injection molding processes include toys, plastic parts, etc.

A particular type of product that is often made via injection molding is an airbag covers. Although airbag systems greatly improve the safety of the vehicle, airbag systems are not visually appealing to consumers. Accordingly, the manufacturer will generally place a decorative airbag cover over the airbag system (such as on the vehicle dashboard, on the steering wheel, etc.). Generally, this airbag cover is a molded piece of thermoplastic that will be visually appealing and will correspond to other themes/colors of the vehicle interior. Thus, by adding this cover, the vehicle owner still gets the benefits of the airbag system while at the same time, enjoys a visually appealing decor of the vehicle interior.

As is known in the art, there are a few known problems associated with using injection molding techniques for producing airbag covers. Specifically, as the molded thermoplastic cools within the mold, “sink marks,” depressions, imperfections and/or other deformities sometimes will appear on the front face of the cover. (The front face is sometimes called the “Class A” surface). These imperfections are unacceptable to both the manufacturer and consumer. If a cover is produced with such an imperfection/deformity, it must be thrown away. Of course, when such a cover is thrown away, the manufacture is wasting money and resources. Accordingly, manufacturers are constantly striving to find ways to reduce the number of imperfect/deformed airbag covers formed during the manufacturing process.

In order to eliminate the number of deformed airbag covers, certain “rules” and procedures have been developed during the injection molding process. For example, it is known that if a wall intersects the cover's front face (Class A surface), then care must be used to ensure that the thickness of the intersecting wall is properly proportioned. If the intersecting wall is “too thick,” then the molded cover is likely to contain a deformity (sink mark) after the cover cools. For example, it is known that airbag covers manufactured using injection molding often have a sink mark found at the bottom (6:00 o'clock) position of the cover because this position is where the thick “hoop” wall intersects the front face of the cover.

Unfortunately, the thickness requirements needed to avoid sink marks in the front face may not correspond with the specifications of the airbag manufacturer. Rather, airbag manufacturers often want to make the cover thicker and stronger for structural/functional reasons. As such, some manufacturers have resorted to using high pressure nitrogen gas as a means of creating thicker walls on the airbag cover. Still other manufacturers have developed complex molding tools with moving parts which will provide the necessary thick, intersecting wall, without increasing the likelihood that the molded cover will have a deformity. Of course, the use of such high pressure gas and/or complex molding tools means that the overall cost and complexity of the manufacturing process is greatly increased.

Accordingly, it would be an advancement in the art to develop a new type of manufacturing process that is inexpensive and easy to use, yet at the same time, reduces the frequency and number of produced covers having an imperfection/deformity. Such a method (and device for implementing this method) is taught herein.

### BRIEF SUMMARY OF THE INVENTION

The present embodiments relate to an apparatus that may be used for a gas assisted injection molding process. Specifically, the apparatus is designed such that it may be used to produce a molded substrate from a thermoplastic material via an injection molding process. Accordingly, the apparatus includes a mold having a mold core side and a cavity side. A molding area is also positioned between the core side and the cavity side. As is known in the art, the molding area is designed such that it will receive a quantity of a thermoplastic material.

The apparatus will generally include an injection unit, which is a tube or other similar device that is designed to introduce the quantity of the thermoplastic into the mold. Specifically, during the manufacturing process, the injection unit will move and engage a portion of the mold, thereby allowing liquid thermoplastic to flow into the mold.

The apparatus is designed for use in a gas assisted injection molding process. For this reason, the apparatus will generally include a gas supply that is capable of introducing a quantity of gas, having a pressure that is less than 500 psi, into the mold during the injection molding process. The gas supply delivers the gas to the core side of the mold. The core side is the “class B” underside of the substrate. Accordingly, if any blemishes or imperfections are created on the substrate by the introduction of the gas, all of these imperfections will be on the class B, underside of the substrate and will not be visible to the consumer.

The gas supply comprises a shop air supply and a high pressure supply. The shop air supply is designed to introduce “shop air”—i.e., regular air that is maintained at or near atmospheric pressure—into the mold. The high pressure supply is designed to introduce gas having a pressure that is greater than about 100 psi but is less than about 500 psi. One or more lines (tubes) may be used to connect the shop air supply and the high pressure supply to the mold.

A pressure regulating assembly is also included as part of the gas supply. This pressure regulating assembly is designed such that it will adjust the pressure of the gas supply, as necessary. Accordingly, the pressure regulating assembly may comprise a solenoid(s), valve(s), and/or pressure regulator(s), as needed, arranged in a manner that allows the regulating assembly to adjust the pressure of the gas. For example, if a pressure of about 400 psi is desired, the pressure regulating assembly will adjust, via valves, pressure regulators, etc., the pressure of the gas produced by the high pressure supply until it achieves the desired pressure.

The apparatus also comprises one or more sintered vents. These sintered vents, are positioned along the core side of the mold. The sintered vents are arranged such that the gas from the gas supply is vented into the mold by passing through the sintered vents. The sintered vents will be positioned on the core side of the mold in positions where it is likely that a sink hole or other defect would likely form. Venting gas onto these areas of the substrate during the molding process reduces the likelihood that a defect will form.

An ejector may also be added to the apparatus. The ejector is a device that is designed to facilitate the ejection of the hardened substrate out of the mold. Specifically, once the substrate has formed and hardened in the mold, the mold will open so that the substrate can be ejected (extracted) from the mold. In order to facilitate this ejection, the ejector will contact the substrate and “push” it out of the mold.

The apparatus provides for an easy and efficient means for molding a substrate from a thermoplastic material. Specifically, the first step in the molding process involves (if necessary) closing the mold. Such closing occurs by compressing together the core side and the cavity side.

Once the mold has been closed (compressed), the thermoplastic material will be injected into the mold. Generally, this will occur by having the injection unit infuse (or otherwise introduce) a quantity of the thermoplastic into the molding area positioned on the interior of the mold. In some embodiments, a gas from the gas supply will be injected into the mold (via the sintered vents) as the thermoplastic is being injected into the mold. This added gas may be “shop air” from the shop air supply that is maintained at atmospheric pressure or, in other embodiments, it may be gas from the high pressure supply that has a pressure that is less than 500 psi.

Once the molding area has been filled and/or partially packed with the thermoplastic material, gas from the gas supply is vented into the filled mold through the sintered vents. This gas will be applied to the cover side (i.e., the class B side of the substrate). The gas flowing out of the sintered vents pressurizes the material against the “class A” surface during this step of the molding process. As noted above, the sintered vents are preferably positioned in locations where sink holes are likely to form during the molding process. Thus, by pressurizing (pushing) the thermoplastic outwardly against the “class A” surface at these locations, the thermoplastic is much less likely to sink or depress inward.

In some of the presently preferred embodiments, the gas that is vented through the sintered vents during this step will be produced by the high pressure supply and will have a pressure that is 400 psi for a period of about 10 seconds. Of course, gases having different pressures and/or different amounts of time may also be used, as desired.

After the gas from the gas supply has been introduced, the substrate is allowed to cool within the mold. At this point, the mold will be opened so that the formed substrate may be ejected from the mold. This ejection may occur using the ejector which operates to push the substrate out of the mold. However, in order to further push the substrate out of the mold, gas from the gas supply may be vented through the sintered vents. Once the molded substrate has been ejected, the manufacturing process may repeat, as desired. Specifically, the method returns to the step of closing the mold so that the manufacturing process may be repeated and another substrate produced.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is cross-sectional view of an apparatus that may be used in the present embodiments;

FIG. 1A is an expanded cross-sectional view of a portion of FIG. 1;

FIG. 2 is a cross-sectional view that includes a representation of a sintered vent according to the present embodiments;

FIG. 3 is a cross-sectional view that shows the molding apparatus as thermoplastic is being introduced into the mold;

FIG. 4 is a cross-sectional view that illustrates the way in which the molded substrate maybe ejected from the apparatus; and

FIG. 5 is flow diagram that illustrates the steps in a method according to the present embodiments.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

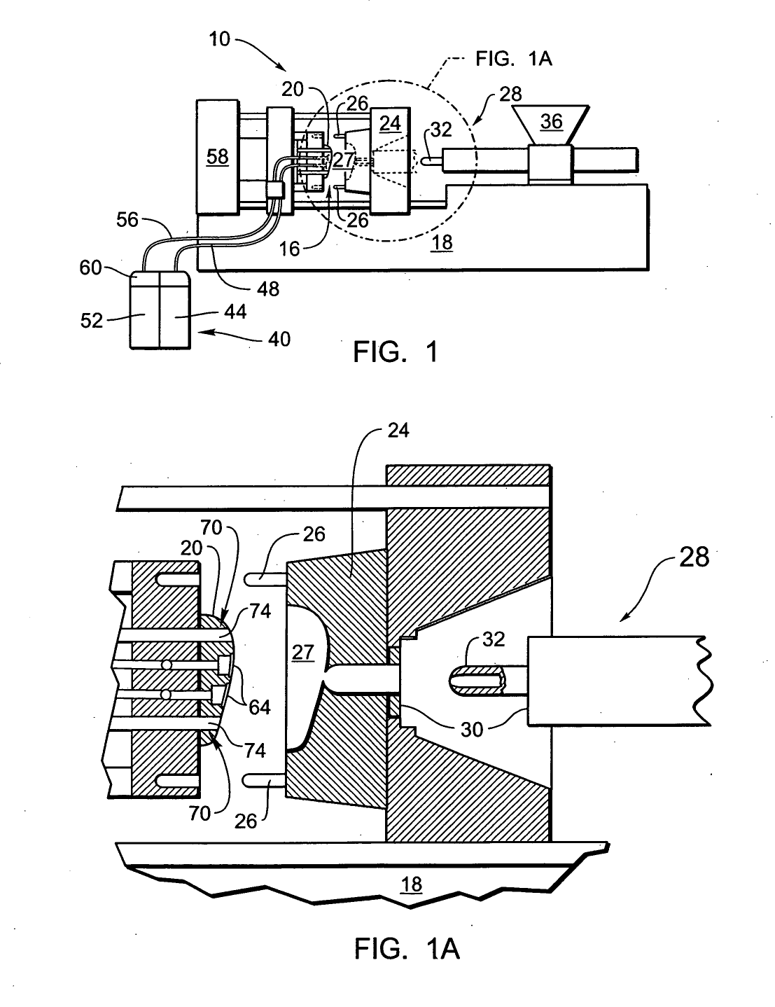

Referring now to FIGS. 1 and 1A, cross-sectional views are shown that illustrate an apparatus 10 that may be used for a gas assisted injection molding process of the present embodiments. FIG. 1A is an expanded view of a portion of FIG. 1.) Specifically, the apparatus 10, as described herein, is designed such that it may be used to produce a molded substrate via an injection molding process. Like other injection molding machines, the apparatus 10 will generally be made of metal and is designed to mold a substrate (not shown in FIG. 1) made of thermoplastic into a desired configuration and shape.

The thermoplastic material used with the present embodiments will generally be a softer, more flexible theremoplastic material of the type currently used to produce airbag covers. These materials are available from suppliers such as the types manufactured by Sumitomo Chemical of Japan and AlphaGary Corporation of Leominster, Mass.

The molding apparatus 10 will generally include a mold 16 that is supported by a base 18. The mold 16 has a mold core side 20 and a cavity side 24. A molding area 27 is also positioned between the core side 20 and the cavity side 24. As is known in the art, the molding area 27 is designed such that it will receive a quantity of a thermoplastic material (which is generally in a liquid form). The core side 20 and the cavity side 24 will be collapsed or compressed together then filled with a sufficient quantity of thermoplastic. As shown in FIGS. 1 and 1A, the mold 16 is in the open, uncompressed configuration. One or more alignment pins 26 may be added to the mold 16 to ensure that the mold 16, when it does compress, will be properly aligned and positioned.

The shape of the core side 20, the cavity side 24 and the molding area 27 are designed such that they will configure the thermoplastic material into a desired shape. Thus, once the thermoplastic material cools and hardens, it will be a molded substrate that has the desired shape and configuration. In the embodiment shown in FIGS. 1 and 1A, the mold 16 is designed to shape a airbag cover. As airbag covers often have a rounded profile, the core side 20 and the cavity side 24 are shown as having this rounded profile. Of course, other shapes/configurations are possible, depending on the shape of the mold 16 and the substrate.

Like other types of injection molding machines, the apparatus 10 will generally include an injection unit 28. This injection unit 28 is a tube or other similar device that is designed to introduce the quantity of the (liquefied) thermoplastic into the mold 16. Specifically, during the manufacturing process, the injection unit 28 will move and engage a portion of the mold 16, namely the injection nozzle seat 30, thereby allowing liquid thermoplastic to flow into the mold 16.

As shown in FIGS. 1 and 1A, the injection unit 28 is positioned on the base 18. Generally, the injection unit 28 will comprise an injection nozzle 32 at one end that infuses/introduces the thermoplastic into the mold 16. A raw material hopper 36 may also be added. This hopper 36 is a funnel or other similar receptacle that is designed such that a user (or machine) may add thermoplastic into the injection unit 28 via the hopper 36. Once the thermoplastic is added into the hopper 36, it will be melted then pushed through the injection unit 28 until it (ultimately) flows out of the nozzle 32 into the mold 16.

The apparatus 10 is designed for use in a gas assisted injection molding process. For this reason, the apparatus 10 will generally include a gas supply 40 that is capable of introducing a quantity of gas into the mold 16 during the injection molding process. As shown in FIG. 1, the gas supply 40 is designed such that it will introduce gas into the molding area 27 along the core side 20. As is known in the art, the core side 20 is the “class B” underside of the substrate. Accordingly, if any blemishes or imperfections are created on the substrate by the introduction of the gas, all of these imperfections will be on the class B, underside of the substrate and will not be visible to the consumer.

In general, the gas supplied by the gas supply 40 is designed such that the gas that is introduced into the mold 16 will be at a pressure less than about 500 psi. As will be explained in greater detail herein, the use of this pressurized gas helps to press the thermoplastic material against the cavity side 24 (i.e., the class A surface) during the molding process, and thus helps to create a substrate that does not have any imperfections, sink marks, or deformities on the class A surface.

The gas supply 40 shown in FIG. 1 comprises a shop air supply 44. The shop air supply 44 is a tank or other source of gas. More than one shop air supply 44 may also be used. As its name suggests, the shop air supply 44 is designed to introduce “shop air”—i.e., regular air that is maintained at or near atmospheric pressure—into the mold 16. Of course, other embodiments may be constructed in which the shop air supply 44 introduces nitrogen gas, helium gas, or another type of gas into the mold 16. However, using regular air as the shop air supply 44 may be beneficial in certain embodiments in that it does not require the manufacture to purchase nitrogen or another type of gas, and thus reduces the overall manufacturing costs associated with the apparatus 10.

A first line 48 is connected to the shop air supply 44. This first line 48 comprises pipes, tubing or other similar features that are capable of transmitting the gas from the shop air supply 44 into the mold 16. The material used to make the first line 48, as well as the length, configuration, and shape of the first line 48, will vary according to the particular embodiments.

The gas supply 40 will also comprise a high pressure supply 52 that is capable of producing gas having a pressure that is greater than about 100 psi but is less than about 500 psi. More than one high pressure supply 52 may also be used. Typically, it has been found that having the high pressure supply 52 produce gas that is 400 psi produces acceptable results. Again, this high pressure supply may be a tank or other device capable of producing and/or channeling gas at the specified pressure.

In some embodiments, the high pressure supply 52 will comprise an air intensifier that is designed to pressurize air to the designed pressure. As with the shop air supply 44, the gas used in the high pressure supply 52 of FIG. 1 is air; however, other embodiments may likewise be made in which the high pressure supply 52 uses nitrogen, helium, or another gas. The high pressure supply 52 is connected to a second line 56. As with the first line 48, the second line 56 comprises pipes, tubing, etc. and is designed to channel the gas produced by the high pressure supply 52 into the mold 16. The first line 48 and the second line 56 are affixed to the mold 16 and held in the proper position by a clamping unit 58.

As shown in FIG. 1, a pressure regulating assembly 60 is also included as part of the gas supply 40. This pressure regulating assembly 60 is designed such that it will adjust the pressure of the gas of the gas supply 40, as necessary. As will be appreciated by one of skill in the art, the pressure regulating assembly 60 may comprise a solenoid(s), timer(s), valve(s), and/or pressure regulator(s), as needed, that are arranged in a manner that allows the regulating assembly to adjust the pressure of the gas. For example, if a pressure of about 400 psi is desired, the pressure regulating assembly 60 will adjust, via valves, pressure regulators, etc., the pressure of the gas produced by the high pressure supply 52 until it achieves the desired pressure.

Likewise, those of skill in the art will also recognize that the regulating assembly 60 (and the components thereof) can be configured such that the regulating assembly 60 adjusts the pressure of the gases simultaneously flowing through the first line 48 and the second line 56. For example, the assembly 60 may adjust the gas(es) such that the gas flowing through the second line 56 be at 400 psi whereas the gas flowing through first line 48 is at 100 psi. Such tailoring of the gas pressures is, in many embodiments, desirable because it means that one area of the substrate may be contacted with a gas at a high pressure whereas a second area of the substrate is contacted with a gas a lower pressure (or vice versa). Thus, if a particular area of the substrate requires a higher gas pressure in order to avoid the formation of sink holes, this higher pressure gas can be added to the area, without affecting other areas of the substrate. As such, the manufacturer can adjust and tailor the gas pressure as needed in order to reduce the likelihood that a sink hole or other deformity will form at a particular area on the substrate.

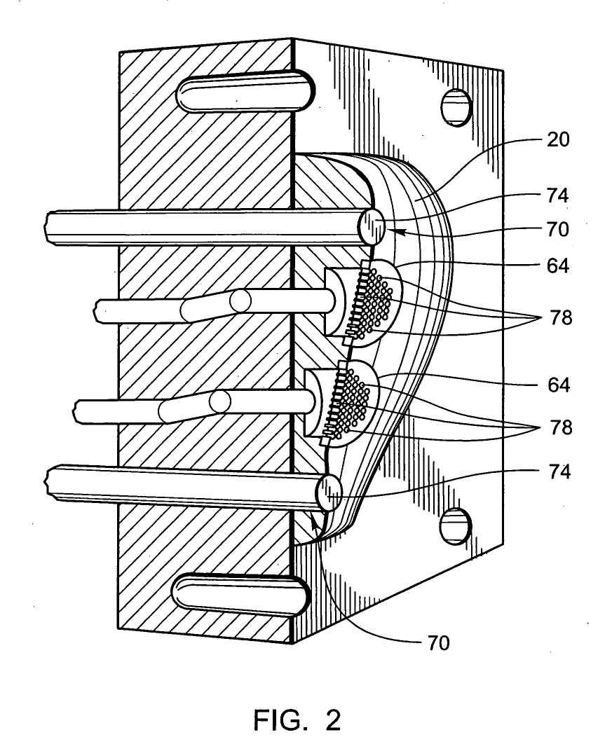

The apparatus 10 also comprises one or more sintered vents 64. These sintered vents 64, which are shown in greater detail in FIGS. 1A and 2, are positioned along the core side 20 of the mold 16. The sintered vents 64 are arranged such that the gas from the gas supply 40 is vented into the mold 16 by passing through the sintered vents 64. By venting the gas through the sintered vents 64 rather than valves, the flow of the gas into the mold 16 is more uniform and can be tailored to specific areas of the substrate (as described above). Accordingly, for these reasons, the use of the sintered valves 64 may be preferred.

The sintered vents 64 will be positioned on the core side 20 of the mold in positions where it is likely that a sink hole or other defect would likely form. Accordingly, areas where the substrate (airbag cover) has a thick cross section are prime locations for the sintered vents 64 may be installed. In this manner, the gas produced by the gas supply 40 may then pass through the sintered vents 64 and contact the substrate in the desired locations.

In the embodiment shown in FIG. 1A, two sintered vents 64 are shown; however, more sintered vents 64 also may be used. For example, if there are multiple areas/portions of the substrate that are likely to form sink holes, a sintered vent 64 could be placed at each of these locations so that gas from the high pressure supply 52 may be directed onto each specific area. Likewise, if additional areas of the substrate require shop air during the manufacturing process, additional sintered vents 64 may be used and connected to the shop air supply 44.

The apparatus 10 may further comprise an ejector 70 (as shown in of FIG. 1A). The ejector 70 is a device that is designed to facilitate the ejection of the hardened substrate out of the mold 16. Specifically, once the substrate has formed and hardened in the mold 16, the mold 16 will open so that the substrate can be ejected (extracted) from the mold 16. In order to facilitate this ejection, the ejector 70 will contact the substrate and “push” it out of the mold 16. Accordingly, as shown in FIGS. 1, 1A, and 2, the ejector 70 comprises one or more extendable ejector pins 74 that will extend from the core side 20 and will push the substrate out of the mold 16. Other types of devices, as known in the art, may also be used as the ejector 70 including lifters, ejector blades, pressurized air vents, etc.

FIG. 2 is a cross-sectional view that provides greater detail for an embodiment of the sintered vent 64. Sintered vents are commercially available from the D-M-E Company of Michigan. As is known in the art, these vents 64 will have one or more pores 78. These pores 78 will have a diameter of 0.5 mm, 0.3 mm, or 0.2 mm, depending upon the particular embodiment. Of course, other pore sizes and pore diameters are also possible.

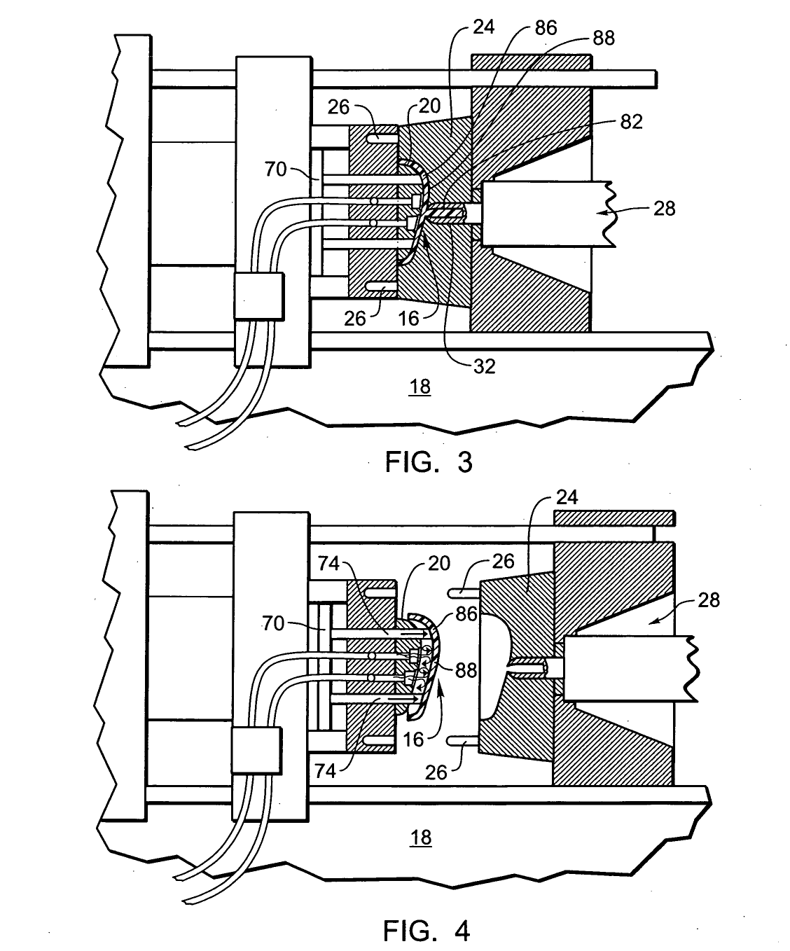

FIG. 3 is a cross-sectional view that shows the apparatus 10 being used during the molding process to form a substrate 86. (In the case of FIG. 3, the substrate 86 is an airbag cover 88 that may be used to cover an airbag system (as described above)). Specifically, FIG. 3 shows the mold 16 as it is being filled with the thermoplastic. Specifically, the mold 16 has been compressed into the closed position such that the cores side 20 is adjacent to the cavity side 24. In this position, the injection nozzle 32 then moves proximate to the cavity side 24 and engages the cavity side 24. Once the mold 16 has been compressed, it may be filled with the thermoplastic by having the thermoplastic flow through the nozzle 32 into the mold 16. In the embodiment shown in FIG. 3, this liquefied thermoplastic will also flow through the hot runner manifold 82 prior to entering the mold 16. Once the thermoplastic is positioned within the mold 16, the thermoplastic material will harden and cool to form the substrate.

FIG. 4 is a cross-sectional view that shows the apparatus 10 after thermoplastic material has cooled and hardened to form the substrate 86. Once the substrate 86 has properly been formed, the mold 16 will open up into its uncompressed state so that the substrate may be removed from the mold 16. In order to facilitate the ejection of the substrate 86 from the interior of the mold 16, the ejector 70 may be used to contact the substrate 86 and push the substrate 86 out of the mold 16. In the embodiment of FIG. 4, the ejector 70 comprises the ejector pins 74. Accordingly, once the substrate 86 has been formed, the ejector pins 74 will extend outwards from the core side 20 and will contact the substrate 86 and push the substrate 86 away from the core side 20 and out of the mold 16.

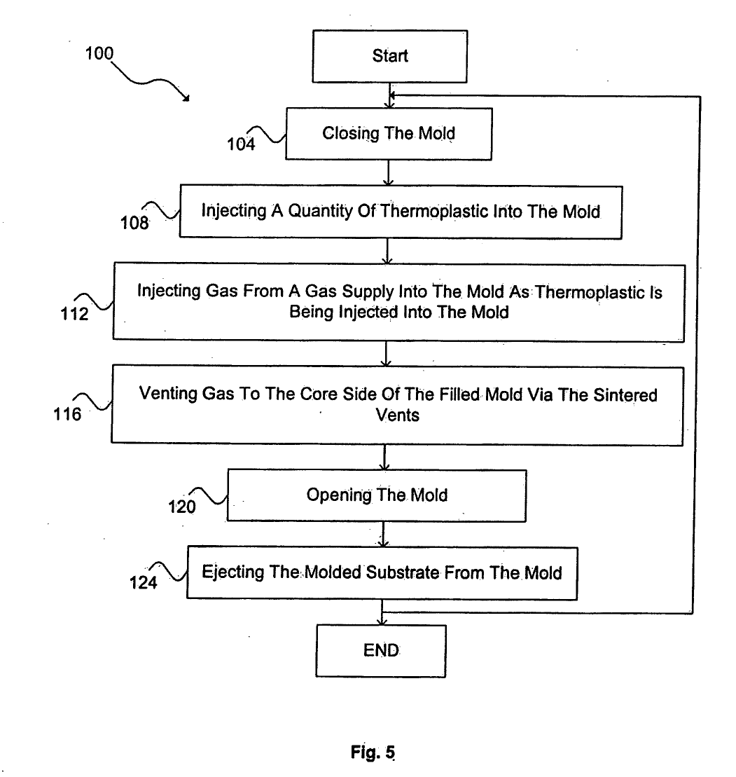

FIG. 5 is a flow diagram that illustrates one embodiment of a gas assisted injection molding method 100 that may be practiced using the apparatus 10. This Figure, taken in conjunction with FIGS. 1-4, illustrates the way in which the apparatus 10 may be used to produce a substrate 86 from a thermoplastic material.

In order to produce the substrate 86, the first step in the method 100 comprises closing 104 the mold 16. As explained above, such closing 104 occurs by compressing together the core side 20 and the cavity side 24. In some embodiments, this closing of the mold 16 will be facilitated and/or caused by the movement of the injection unit 28—i.e., the movement of the injection unit 28 towards and contacts the mold 16 and causes the cavity side 24 and the core side 20 to compress together leaving a molding volume that is capable of molding the substrate. In other embodiments, the cavity side 24 and the core side 20 will compress and then the injection unit 28 will move.

Once the mold 16 has been closed (compressed), the thermoplastic material will be injected 108 into the mold 16. Generally, this will occur by having the injection nozzle 32 infuse (or otherwise introduce) a quantity of the thermoplastic into the molding area 27 positioned on the interior of the mold 16. In some embodiments, the method 100 will further include the step of injecting 112 a gas from the gas supply 40 into the mold 16 as the thermoplastic is being injected into the mold 16. As explained above, this gas from the supply 40 will flow into the mold 16 via the sintered vents 64. The gas from the gas supply 40 may be “shop air” from the shop air supply 44 that is maintained at atmospheric pressure. In other embodiments, the gas that is introduced as the thermoplastic is being injected into the mold 16 is from the high pressure supply 52 and thus has a pressure that is less than 500 psi (and more preferably between about 100 psi to about 500 psi). In other embodiments, this gas introduced from the gas supply 40 may be a combination of the air from the high pressure supply 52 and the shop air supply 44.

Once the molding area 27 has been filled and/or partially packed with the thermoplastic material, gas from the gas supply 40 is vented 116 into the filled mold 16 through the sintered vents 64. This gas may be from the shop air supply 44 or the high pressure supply 52 and will be applied to the cover side 20 (i.e., the class B side of the substrate 86). The gas flowing out of the sintered vents 64 pressurizes the material against the “class A” surface during this step of the molding process. As noted above, the sintered vents 64 are preferably positioned in locations where sink holes are likely to form during the molding process. However, by pressurizing (pushing) the thermoplastic outwardly against the “class A” surface at these locations, the thermoplastic is much less likely to sink or depress inward. As such, the likelihood that sink holes or other deformities will form in the substrate 86 at these locations is greatly reduced.

In some of the presently preferred embodiments, the gas that is vented through the sintered vents 64 during this step will be produced by the high pressure supply 52 and will have a pressure that is 400 psi. This supply of pressurized gas will be added to the molding area 27 for a period of time sufficient to produce a quality part (which in some embodiments may be about 10 seconds) Of course, other times are clearly possible depending upon the application. Of course, other embodiments may be designed in which one or more portions of the substrate 86 is contacted with gas from the high pressure supply 52 (and has a pressure of about 100 to 500 psi) whereas one or more other portions of the substrate are contacted with gas from the shop air supply 44 (and is generally maintained at about atmospheric pressure), etc. In this way, the manufacturer can tailor the use of the pressurized gas to portions of the substrate 86 that are more likely to form deformities, while at the same time, tailor the use of the shop air to optimize the manufacturing process.

After the gas from the gas supply 40 has been introduced, the substrate 86 is allowed to cool within the mold 16. At this point, the mold 16 will be opened (as shown in step 120) so that the formed substrate 86 may be ejected 124 from the mold 16. This ejection process will generally involve the ejector 70 which will contact the substrate 86 and will push the substrate 86 out of the mold 16. Of course, in order to further push the substrate 86 out of the mold 16, gas from either the high pressure supply 52 and/or the shop air supply 44 may be vented through the sintered vents 64 and used to further eject the molded substrate 86.

Once the molded substrate 86 has been ejected, the method 100 may repeat, as desired. Specifically, the method 100 returns to the step 104 of closing the mold 16 so that the manufacturing process may be repeated and another substrate produced.

Those of skill in the art will readily recognize that the apparatus 10 and the method 100 of the present embodiments provide significant advantages. Not only do the present embodiments provide a cheap and easy method of manufacturing, but these embodiments can also reduce the issues of delamination (i.e., the splitting of the covers into layers) that sometimes occurs around the airbag cover's tear seam. As is known in the art, delamination of the airbag cover sometimes occurs around the tear seam because of the high pressures and/or long molding times that are associated with previously known injection molding processes for producing airbag covers. These molding processes require the use of these high pressures/long molding times as a means of preventing the formation of sink holes/deformations in the cover. However, as explained in greater detail herein, the present embodiments provide a simple and easy way to eliminate the formation of sink holes, without the use of higher pressures and/or long molding times. Accordingly, the risk that the covers formed by the present embodiments will have problems with delamination is significantly reduced.

Moreover, it should be noted the present embodiments ability to form substrate (airbag covers) using gas that has a pressure of less than 500 psi is unexpected. Specifically, prior to making the present embodiments, it was believed that the sintered vents would have to be used with gases of pressures greater than 500 psi in order to produce airbag covers lacking sink holes or other deformities. However, because soft materials were used for the thermoplastic, it was found that gas of pressures less than 500 psi would produce the desired results.

It should also be noted that one or more of the following additional benefits may also be available to manufacturers using the embodiments described herein to manufacture molded airbag covers: (1) shorter processing times for molding process (and thus faster production rates); (2) less stresses (residual stresses) being present in the molded airbag covers; (3) thicker and stronger intersecting walls that conform with the specifications; and/or (4) reduced deformation of the cover caused by the ejector. Accordingly, such advantages means that the use of the present embodiments desirable.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A gas assisted method for molding a substrate, the method comprising:
injecting a quantity of thermoplastic into a mold having a core side and a cavity side, wherein the mold is designed to mold a substrate when filled with the thermoplastic;
venting gas to the core side of the mold while the thermoplastic is in the mold, wherein the gas has a pressure less than 500 psi and is vented into the mold via sintered vents; and
ejecting the substrate from the mold.

2. A method as in claim 1 further comprising the step of closing the mold after the substrate has been ejected from the substrate.

3. A method as in claim 1 further comprising the step of injecting the gas into the mold as the thermoplastic is being injected into the mold.

4. A method as in claim 3 wherein the gas that is injected into the mold as the thermoplastic is being injected into the mold is shop air.

5. A method as in claim 1 wherein the ejecting step comprises:
opening the mold;
using an ejector to separate the substrate from the mold; and
adding a quantity of gas to assist pushing the substrate out of the mold.

6. A method as in claim 5 wherein the gas used to push the substrate out of the mold is shop air.

7. A gas assisted method for molding a substrate the method comprising:
injecting a quantity of thermoplastic into a mold having a core side and a cavity side, wherein the mold is designed to mold a substrate when filled with the thermoplastic;
injecting a quantity of gas from a gas supply into the mold as the thermoplastic is being injected into the mold, wherein the gas has a pressure less than 500 psi and is vented into the mold via sintered vents;
venting gas having a pressure between about 100 psi and about 400 psi to the core side of the mold via the sintered vents while the thermoplastic is in the mold;
opening the mold; and
ejecting the substrate from the mold.

8. A method as in claim 7 further comprising the step of closing the mold after the substrate has been ejected.

9. A method as in claim 7 wherein the gas supply comprises
a high pressure supply capable of producing gas having a pressure that is greater than about 100 psi and less than about 500 psi; and
a shop air supply.

10. A method as in claim 7 further comprising a pressure regulating assembly that determines the pressure of the gas that is used during the manufacturing process.

11. An apparatus for gas injection molding comprising:
a mold;
an injection unit for injecting a quantity of thermoplastic into the interior of the mold, wherein the mold is designed to mold a substrate from the thermoplastic;
a gas supply that delivers gas at a pressure of less than 500 psi when the thermoplastic in is the mold, wherein the gas is introduced into the mold by passing through a sintered vent;
an ejector designed to eject the substrate from a molding area of the mold.

12. An apparatus as in claim 11, wherein the apparatus is designed to mold airbag covers.

13. An apparatus as in claim 12 further comprising a pressure regulating assembly that determines the pressure of the gas that is used during the manufacturing process.

14. An apparatus as in claim 11 wherein the gas supply comprises
a high pressure supply capable of producing gas having a pressure that is greater than about 100 psi and less than about p to 500 psi; and
a shop air supply.

15. An apparatus as in claim 14 further comprising an air intensifier designed to produce the gas for the high pressure supply.

16. An apparatus as in claim 11 wherein the ejector comprises one or more ejector pins.
